(19) United States
(12) Patent Application Publication
(10) Pub. No.: US 2011/0247853 A1
(43) Pub. Date: Oct. 13, 2011

(54) GAS BUSHING

(75) Inventors: Ishinori Ochiai, Tokyo (JP); Yuji Yoshitomo, Tokyo (JP); Toru Yamashita, Tokyo (JP)

(73) Assignee: MITSUBISHI ELECTRIC CORPORATION

(21) Appl. No.: 13/140,268

(22) PCT Filed: Feb. 24, 2009
(86) PCT No.: PCT/JP2009/053260

§ 371 Date: Jun. 16, 2011

(51) Int. Cl. H02G 15/23

(52) U.S. Cl. 174/19

(57) ABSTRACT

A gas bushing is constructed in such a manner that a center conductor includes: a main electrically-conductive portion having a first outside diameter; and a larger-diameter portion being provided in an upper end portion of the center conductor and having a second outside diameter that is larger than the first outside diameter; and a connection portion connecting the main electrically-conductive portion and the larger-diameter portion together; a lower end of the larger-diameter portion is positioned lower than a lower end of the flange portion, and the lower end of the larger-diameter portion and an upper end of the connection portion are connected together in such a manner that a curvature of an external surface of the center conductor is continuous and that a connecting section has a round shape.

### TECHNICAL FIELD

The present invention relates to a gas bushing.

### BACKGROUND ART

Examples of conventional gas bushings include a gas bushing obtained by having a center conductor extend through the inside of a porcelain hollow insulator filled with electrically-insulating gas, as shown in FIGS. 6 and 7 of Patent Document 1. Another example is a gas bushing obtained by having a center conductor extend through the inside of a hollow insulator, the hollow insulator being a so-called polymer hollow insulator made up of a Fiber Reinforced Plastic (FRP) cylinder and a rubber external cover, as shown in FIG. 5 of Patent Document 2. In each of these conventional examples, the outside diameter of the center conductor is regular.

Yet another conventional example is a gas bushing obtained by connecting together a center conductor and a connection conductor provided in an upper end portion, which are provided as separate component parts, and providing a shield for the connection portion. In this example, the diameter of the connection conductor is arranged to be larger than the diameter of the center conductor. However, because it is required to have a structure that allows the conductors to be connected together by a bolt as well as the shield for the connection portion, the diameter of each of the conductors is limited by this requirement.

Further, as shown in FIG. 5 of Patent Document 2, a metal flange made of metal is attached to an upper end portion of the gas bushing. Also, in FIG. 2 of Patent Document 2, a metal flange is attached, although no reference numeral is used.
Patent Document 1: Japanese Patent Application Laid-open No. H6-231636
Patent Document 2: Japanese Patent Application Laid-open No. H10-188697

### DISCLOSURE OF INVENTION

### Problem to be Solved by the Invention

In Patent Document 2 listed above, the metal flange made of metal (hereinafter, the “upper metal flange” is attached to the upper end portion of the gas bushing. As for the electric potential in the surrounding of the upper metal flange, equipotential lines run on the inside of the bushing from the tip end (i.e., the lower end) of the metal flange, as shown in FIG. 3 of Patent Document 2. For this reason, a problem is observed where the electric field at the tip end of the upper metal flange is so high that a partial electric discharge or a flashover may occur.

In view of the problem described above, it is an object of the present to provide a gas bushing having improved withstand voltage characteristics in the surrounding of the upper metal flange.

### Means for Solving Problem

In order to solve the aforementioned problems and attain the aforementioned object, a gas bushing according to one aspect of the present invention is constructed in such a manner as to include: a hollow insulator obtained by filling an inside of a circular cylinder member with electrically-insulating gas, the circular cylinder member having an inside diameter that is regular regardless of heights; a center conductor extending through the inside of the hollow insulator; and a flange portion made of metal and attached to an upper end of the hollow insulator, wherein the center conductor includes: a main electrically-conductive portion having a first outside diameter; and a connection portion connecting the main electrically-conductive portion and the large-diameter portion together; a lower end of the larger-diameter portion is positioned lower than a lower end of the flange portion, and the lower end of the larger-diameter portion and an upper end of the connection portion are connected together in such a manner that a curvature of an external surface of the center conductor is continuous and that a connecting section has a round shape.

### Effect of the Invention

According to an aspect of the present invention, the outside diameter of the larger-diameter portion of the center conductor is arranged to be larger than the outside diameter of the main electrically-conductive portion, and also, the position of the lower end of the larger-diameter portion is arranged to be lower than the position of the lower end of the flange portion. As a result, it is possible to lower the electric field positioned at the lower end of the flange portion. Consequently, an advantageous effect is achieved where it is possible to improve the withstand voltage characteristics in the surrounding of the flange portion and to inhibit occurrence of partial electric discharges or flashovers.

### BRIEF DESCRIPTION OF DRAWINGS

FIG. 1 is a vertical cross-sectional view of a gas bushing according to a first embodiment of the present invention.

FIGS. 2(a) and 2(b) are drawings for explaining equipotential line distributions in surroundings of a metal flange; FIG. 2(a) is a drawing of a gas bushing according to the first embodiment; and FIG. 2(b) is a drawing of a conventional gas bushing.

### EXPLANATIONS OF LETTERS OR NUMERALS

1 Hollow insulator
2 Center conductor
2a Larger-diameter portion
2b Main electrically-conductive portion
2c Lower end
3 Atmosphere-side high-voltage shield
4a Tip end portion
4c Metal flange tip end
4 Metal flange
6 Internal ground shield
7 Aerial terminal

### BEST MODE(S) FOR CARRYING OUT THE INVENTION

In the following sections, exemplary embodiments of a gas bushing according to the present invention will be explained in detail, with reference to the accompanying drawings. The present invention is not limited to the exemplary embodiments.

### First Embodiment

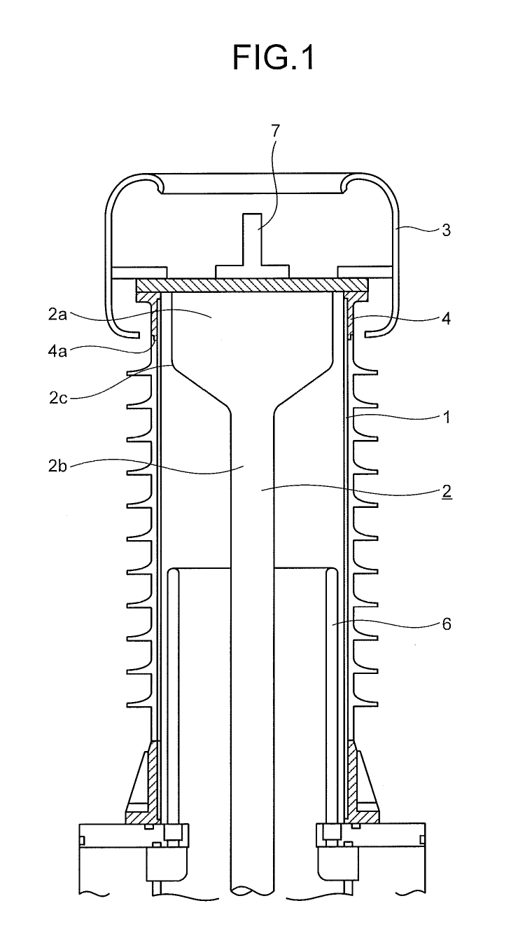

FIG. 1 is a vertical cross-sectional view of a gas bushing according to a first embodiment of the present invention. As shown in FIG. 1, the gas bushing according to the first embodiment includes: a hollow insulator 1 of which the inside is filled with electrically-insulating gas; a center conductor 2 extending through the inside of the hollow insulator 1; an aerial terminal 7 provided in a head portion of the gas bushing; an atmosphere-side high-voltage shield 3 provided in the surrounding of the aerial terminal 7; a metal flange 4 serving as a flange portion and being attached to an upper end of the hollow insulator 1; and an internal ground shield 6 provided in a lower part of the hollow insulator 1.

For example, the hollow insulator 1 is configured by providing an electrically-insulating external cover that has a plurality of brims on the outer circumferential surface of a circular cylinder made of Fiber Reinforced Plastic (FRP).

In FIG. 1, a larger-diameter portion 2a having a larger outside diameter than that of a main electrically-conductive portion 2b is provided in an upper end portion of the center conductor 2. Further, the outside diameter of the larger-diameter portion 2a is configured so as to approximate the inside diameter of the hollow insulator 1. In other words, when the outside diameter of the main electrically-conductive portion 2b is expressed as a first outside diameter, whereas the outside diameter of the larger-diameter portion 2a is expressed as a second outside diameter, it is desirable to arrange the second outside diameter to be larger than the first outside diameter and to further arrange the second outside diameter to be substantially equal to the inside diameter of the hollow insulator 1. For example, the larger-diameter portion 2a may be configured so as to be hollow and to have an annular shape in a cross section.

Further, in the first embodiment, a lower end 2c of the larger-diameter portion 2a is arranged to position lower than a tip end portion 4a of the metal flange 4. More specifically, the length (in the vertical direction) of the larger-diameter portion 2a is set so as to satisfy the positional relationship described above between the lower end 2c of the larger-diameter portion 2a and the tip end portion 4a of the metal flange 4. It should be noted, however, that the length of the larger-diameter portion 2a is sufficient when being equal to or shorter than approximately twice the length of the metal flange 4. The reason is that when the length of the larger-diameter portion 2a is too long, the electric-insulation distance from the internal ground shield 6 becomes too short.

Further, the outside diameter of the portion connecting the larger-diameter portion 2a and the main electrically-conductive portion 2b together is configured so as to change smoothly. More specifically, the outside diameter of the center conductor 2 smoothly and monotonically decreases from the lower end 2c downward in order of a curve, a straight line, and a curve. After that, the outside diameter of the center conductor 2 becomes equal to the outside diameter of the main electrically-conductive portion 2b. In the first embodiment, the larger-diameter portion 2a and the main electrically-conductive portion 2b are integrally formed.

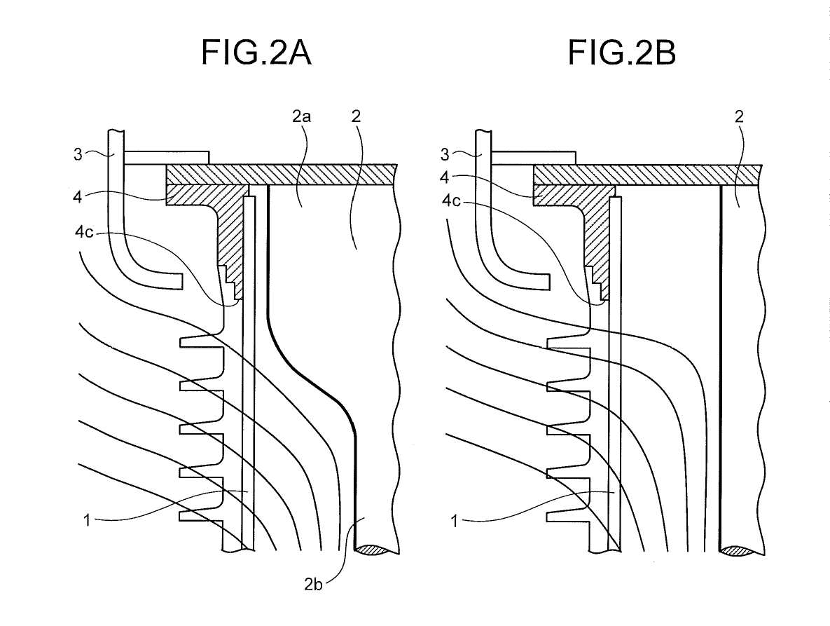

In FIGS. 2(a) and 2(b), equipotential line distributions in surroundings of the metal flange 4 is shown. FIG. 2(a) is a drawing of an equipotential line distribution according to the first embodiment; and FIG. 2(b) is a drawing of an equipotential line distribution of a conventional gas bushing. As shown in FIG. 2(b), with the conventional gas bushing, the equipotential lines run on the inside of the hollow insulator 1 from the vicinity of a metal flange tip end 4c, which is the lower end of the metal flange 4. The intervals between the equipotential lines become smaller with respect to the axial direction of the hollow insulator 1, so that the electric field is high near the metal flange tip end 4c. In contrast, as shown in FIG. 2(a), with the gas bushing according to the first embodiment, the equipotential lines do not run on the inside of the hollow insulator 1 in the vicinity of the metal flange tip end 4c, because of the larger-diameter portion 2a of the center conductor 2. Thus, the intervals between the equipotential lines in the axial direction are larger than those in the conventional example. Consequently, it is possible to keep the electric field near the metal flange tip end 4c low.

In the first embodiment, the outside diameter of the larger-diameter portion 2a of the center conductor 2 is arranged to be larger than the outside diameter of the main electrically-conductive portion 2b. Also, the lower end 2c of the larger-diameter portion 2a is arranged to position lower than the metal flange tip end 4c. Thus, it is possible to keep the electric field near the metal flange tip end 4c low. Consequently, an advantageous effect is achieved where it is possible to improve the withstand voltage characteristics in the surrounding of the metal flange tip end 4c and to inhibit occurrence of partial electric discharges or flashovers.

Further, because the upper end portion of the center conductor 2 is arranged to have a larger diameter and to serve as the larger-diameter portion 2a, advantageous effects are achieved where heat generation in the upper end portion is inhibited, where thermal conduction to the aerial terminal 7 is promoted, and where the strength of the upper end portion against operational vibrations, earthquakes, or the like is improved. Consequently, it is possible to further improve the reliability of the gas bushing with respect to the thermal characteristics thereof and the strength thereof.

In addition, according to the first embodiment, another advantageous effect is achieved where the electric field is pressed downward and weakened by the larger-diameter portion 2a. Consequently, it is possible to configure the atmosphere-side high-voltage shield 3 so as to be smaller than that in the conventional example.

Further, because the outside diameter of the larger-diameter portion 2a is arranged to be substantially equal to the inside diameter of the hollow insulator 1, it is possible to inhibit the equipotential lines near the metal flange tip end 4c from running on the inside. Consequently, it is possible to further improve the withstand voltage characteristics mentioned above. It is desirable to arrange the larger-diameter portion 2a to be out of contact with the hollow insulator 1. If the larger-diameter portion 2a were in contact with the hollow insulator 1, the heat generated due to the electric conduction of the center conductor 2 would travel to the hollow insulator 1, so that the hollow insulator 1 would have a higher temperature.

Further, in the first embodiment, the center conductor 2 including the portions having the mutually different diameters is integrally formed. Thus, it is possible to reduce the number of component parts being used and to omit an electrically-conductive connection portion. Consequently, it is possible to achieve a cost reduction and a reliability improvement.

Further, the outside diameter of the portion connecting the larger-diameter portion 2a and the main electrically-conductive portion 2b together is configured so as to change smoothly. Thus, the electric field is lower than that in the example in which the outside diameter does not change smoothly. Consequently, an advantageous effect is achieved where it is possible to inhibit occurrence of partial electric discharges or flashovers.

### INDUSTRIAL APPLICABILITY

An aspect of the present invention is useful as a gas bushing used in a state in which it is attached to high-voltage equipment.

1. A gas bushing comprising:
a hollow insulator obtained by filling an inside of a circular cylinder member with electrically-insulating gas, the circular cylinder member having an inside diameter that is regular regardless of heights;
a center conductor extending through the inside of the hollow insulator; and
a flange portion made of metal and attached to an upper end of the hollow insulator, wherein
the center conductor includes: a main electrically-conductive portion having a first outside diameter; and a larger-diameter portion being provided in an upper end portion of the center conductor and having a second outside diameter that is larger than the first outside diameter; and a connection portion connecting the main electrically-conductive portion and the larger-diameter portion together;
a lower end of the larger-diameter portion is positioned lower than a lower end of the flange portion, and
the lower end of the larger-diameter portion and an upper end of the connection portion are connected together in such a manner that a curvature of an external surface of the center conductor is continuous and that a connecting section has a round shape.

2. The gas bushing according to claim 1, wherein the second outside diameter is substantially equal to an inside diameter of the hollow insulator.

3. The gas bushing according to claim 1, wherein the larger-diameter portion and the main electrically-conductive portion are integrally formed.

4. The gas bushing according to claim 1,
wherein the curvature of the external surface of the center conductor changes continuously in a section from the lamer-diameter portion to the main electrically-conductive portion.

5. The gas bushing according to claim 1, wherein a length of the larger-diameter portion in an axial direction is equal to or smaller than twice a length of the flange portion in the axial direction.

6. The gas bushing according to claim 1, comprising:
an aerial terminal provided above the larger-diameter portion; and
an external shield that covers surroundings of the aerial terminal and the flange portion so as to provide a shield against an electric field, wherein
an exterior shape of the connection portion in a vertical cross section is defined in order of a curve portion, a straight portion, and a curve portion starting from an upper end of the connection portion toward a lower end thereof, and
a lower end portion of the external shield is positioned on a line extended from the straight portion.

7. The gas bushing according to claim 1, wherein
the center conductor has a hollow structure that is annular in a horizontal cross section, and
a space inside the center conductor is isolated from a space outside the center conductor.

8. The gas bushing according to claim 2, wherein the larger-diameter portion and the main electrically-conductive portion are integrally formed.

9. The gas bushing according to claim 2, wherein the curvature of the external surface of the center conductor changes continuously in a section from the larger-diameter portion to the main electrically-conductive portion.

10. The gas bushing according to claim 3, wherein the curvature of the external surface of the center conductor changes continuously in a section from the larger-diameter portion to the main electrically-conductive portion.

11. The gas bushing according to claim 8, wherein the curvature of the external surface of the center conductor changes continuously in a section from the larger-diameter portion to the main electrically-conductive portion.

12. The gas bushing according to claim 2, wherein a length of the larger-diameter portion in an axial direction is equal to or smaller than twice a length of the flange portion in the axial direction.

13. The gas bushing according to claim 3, wherein a length of the larger-diameter portion in an axial direction is equal to or smaller than twice a length of the flange portion in the axial direction.

14. The gas bushing according to claim 8, wherein a length of the larger-diameter portion in an axial direction is equal to or smaller than twice a length of the flange portion in the axial direction.

15. The gas bushing according to claim 4, wherein a length of the larger-diameter portion in an axial direction is equal to or smaller than twice a length of the flange portion in the axial direction.

16. The gas bushing according to claim 2, comprising:
an aerial terminal provided above the larger-diameter portion; and
an external shield that covers surroundings of the aerial terminal and the flange portion so as to provide a shield against an electric field, wherein
an exterior shape of the connection portion in a vertical cross section is defined in order of a curve portion, a straight portion, and a curve portion starting from an upper end of the connection portion toward a lower end thereof, and
a lower end portion of the external shield is positioned on a line extended from the straight portion.

17. The gas bushing according to claim 3, comprising:
an aerial terminal provided above the larger-diameter portion; and
an external shield that covers surroundings of the aerial terminal and the flange portion so as to provide a shield against an electric field, wherein
an exterior shape of the connection portion in a vertical cross section is defined in order of a curve portion, a straight portion, and a curve portion starting from an upper end of the connection portion toward a lower end thereof, and
a lower end portion of the external shield is positioned on a line extended from the straight portion.

18. The gas bushing according to claim 8, comprising:
an aerial terminal provided above the larger-diameter portion; and
an external shield that covers surroundings of the aerial terminal and the flange portion so as to provide a shield against an electric field, wherein
an exterior shape of the connection portion in a vertical cross section is defined in order of a curve portion, a straight portion, and a curve portion starting from an upper end of the connection portion toward a lower end thereof, and
a lower end portion of the external shield is positioned on a line extended from the straight portion.

19. The gas bushing according to claim 4, comprising:
an aerial terminal provided above the larger-diameter portion; and
an external shield that covers surroundings of the aerial terminal and the flange portion so as to provide a shield against an electric field, wherein
an exterior shape of the connection portion in a vertical cross section is defined in order of a curve portion, a straight portion, and a curve portion starting from an upper end of the connection portion toward a lower end thereof, and
a lower end portion of the external shield is positioned on a line extended from the straight portion.

20. The gas bushing according to claim 5, comprising:
an aerial terminal provided above the larger-diameter portion; and
an external shield that covers surroundings of the aerial terminal and the flange portion so as to provide a shield against an electric field, wherein
an exterior shape of the connection portion in a vertical cross section is defined in order of a curve portion, a straight portion, and a curve portion starting from an upper end of the connection portion toward a lower end thereof, and
a lower end portion of the external shield is positioned on a line extended from the straight portion.
